(19) United States
(12) Patent Application Publication
(10) Pub. No.: US 2015/0345744 A1
(43) Pub. Date: Dec. 3, 2015

(54) Tab Locked Reflector Assembly System Providing Various Sized Upper Orifices

(71) Applicant: Todd A. Guertin, Norwich, CT (US)

(72) Inventor: Todd A. Guertin, Norwich, CT (US)

(73) Assignee: PATHWAY LIGHTING PRODUCTS, INC., Old Saybrook, CT (US)

(21) Appl. No.: 14/294,425

(22) Filed: Jun. 3, 2014

(51) Int. Cl. F21V 7/10; F21V 21/02

(52) U.S. Cl. CPC F21V 7/10; F21V 21/02

(57) ABSTRACT

A tab locked reflector assembly system includes a reflector member and a top plate. The reflector member has a body section and multiple tabs extending upwardly from an upper edge of the body section. The top plate has multiple slots with each tab of the reflector being received within a corresponding slot of the top plate. The reflector member is mounted to the top plate by inserting the tabs through the corresponding slots and bending the tabs orthogonally to the reflector member body section.

### BACKGROUND

This disclosure relates generally to light fixture reflector assemblies. More particularly, this disclosure relates to downlight fixture reflector assemblies.

Recessed light fixtures are light fixtures which are recessed behind a planar surface, such as a ceiling, wall, or floor. The fixtures are designed such that light exits the fixture through a hole or opening in the planar surface. The fixtures are primarily used in ceilings, for example the light fixture discussed below.

Since generally no components of the fixture hang down below the plane of the ceiling, use of the fixtures allows lighting designers to illuminate a workspace while maintaining a smooth ceiling line. Thus, illumination is provided while the source of the light is, in effect, concealed. Since the light source is located completely behind the planar surface of the ceiling, efficiency concerns require the light from the source to be collected and focused outward through the opening in the planar surface. Typically, this is accomplished through the use of a reflector assembly having an upper section that is located above and around the sides of the light source and a lower section that is generally conical in shape, has round light exit aperture, and produces a generally conical shaped area of illumination.

It is often desirable to provide kick reflectors that optimize the wall washing light by minimizing the distance from the plane of the ceiling down the wall to the wall wash light. For instance, typical kick reflectors have a reflecting surface that terminates well above the light exit aperture of the luminaire. Additionally, windows cut out in the down light reflector terminate above a trim flange thus shielding the lower edge of the wall wash reflector. This configuration limits the angle at which the light may be reflected toward the wall, thus leaving a large area of darkness on the wall above the wall washing light.

Conventionally, the reflector may be manufactured as a unitary construction, with the upper and lower sections being formed as a single structure. Alternatively, the upper section (or the top of the upper section) and lower section may be manufactured as separate elements that are mounted together by an inside swage, an outside swage or by rivets.

With an inside swage, the upper section is swaged onto the lower section with the lower end of the upper section being folded over to abut the upper inside surface of the lower section. The inside swage operation produces a clean look but when the reflector is installed the lower end of the upper section can be seen. Also, during assembly of the reflector the upper section is free to rotate with regard to the lower section. To prevent such rotation, the tooling must be adjusted precisely and constantly monitored. If the tooling exerts too much pressure to prevent the rotation, the upper and lower sections may be crushed in the area of the swage.

With an outside swage, the lower section is swaged onto the upper section with the upper end of the lower section being folded to abut the outside surface of the top of the upper section. The material of the top of the upper section conceals the swage when the trim is installed. Unfortunately, with this process, as with the outside swage, rotation between the upper and lower sections is possible during assembly.

Riveting is cost effective and works well to keep the components from rotating. Unfortunately, rivets can be seen from the inside and machine riveting is difficult with small aperture reflectors requiring special tooling/rivet anvils to be produced.

Modern LED light modules have a variety of different shapes and performance factors, requiring various size openings in the top of downlight reflectors and/or various reflector profiles. Each of the type of reflectors described above require different tooling to produce the opening/profile required for each of these LED modules.

### SUMMARY

There is provided a tab locked reflector assembly system comprising a reflector member and a top plate. The reflector member has a body section and multiple tabs extending upwardly from an upper edge of the body section. The top plate has multiple slots with each tab of the reflector being received within a corresponding slot of the top plate. The reflector member is mounted to the top plate by inserting the tabs through the corresponding slots and bending the tabs orthogonally to the reflector member body section.

The reflector member body section upper edge includes an opening having a diameter, the opening receiving an electrical receptacle or the base of an LED module.

The reflector member body section also includes a sidewall extending from the upper edge to a lower edge, the lower edge defining a light exit aperture having a diameter.

The reflector member body section may also include a trim ring extending radially outward from the lower edge.

The reflector member body section may also include a trim ring having a first section extending radially outward from the lower edge and a second section extending upward and radially outward from the first section.

The reflector member body section sidewall has a height and an inner surface having a curvilinear shape. The height of the body section, the curvature of the inner surface, the diameter of the opening and the diameter of the light exit aperture having predetermined values.

The top plate is a substantially planar circular disc having a circumferential outer edge and an inner edge defining an inner opening.

The top plate inner opening has a diameter adapted interface with specific LED modules.

The diameter of the top plate inner opening may be substantially equal to the diameter of the body section opening, with the slots extending radially outward from the top plate inner edge.

The diameter of the top plate inner opening may be smaller than the diameter of the body section opening, with the slots positioned at a distance radially outward from the inner edge.

The reflector member body section sidewall may define at least one opening and the reflector assembly system may further comprise at least one kicker plate disposed adjacent the sidewall opening whereby light emitted transversely outward through the sidewall opening is reflected substantially downward by the kicker plate.

The reflector assembly system may further comprise brackets mounting the at least one kicker plate to the top plate.

The reflector member body section sidewall may define a pair of oppositely disposed openings and the reflector assembly system may further comprise two kicker plates with one of the kicker plates disposed adjacent each of the sidewall openings.

The reflector assembly system may further comprise multiple spring clips, each of which includes an upper segment and a lower segment. The upper segment has an upper end and a lower end. The upper segment upper end is mounted to the top plate. The lower segment extends radially outward from the upper segment lower end. The lower segment has a distal end segment adapted to engage a lighting fixture.

The spring clip lower segment may have a proximal end segment mounted to the spring clip upper segment lower end.

There is also provided a lighting reflector assembly system comprising multiple varieties of reflector members and multiple varieties of top plates. Each reflector member includes an upper edge, a lower edge and a sidewall extending from the upper edge to the lower edge. The upper edge defines an opening having a diameter, the lower edge defines a light exit aperture having a diameter, the sidewall has a height and an inner surface having a curvilinear shape. The sidewall height, the curvature of the sidewall inner surface, the diameter of the opening and the diameter of the light exit aperture of each variety of the reflector members defines a combination of characteristics of the variety of the reflector members, such that the combination of characteristics of each variety of the reflector members is different from the combination of characteristics of each other variety of the reflector members. Each top plate is a substantially planar circular disc having a circumferential outer edge defining a diameter and an inner edge forming an inner opening defining a diameter. The diameter of the inner edge and the diameter of the outer edge of each variety of the top plates defines a combination of characteristics of the variety of the top plates, such that the combination of characteristics of each variety of the top plates is different from the combination of characteristics of each other variety of the top plates. The reflector members and the top plates are structured so each variety of the reflector members is mountable to each variety of the top plates.

### BRIEF DESCRIPTION OF THE DRAWINGS

The present disclosure may be better understood and its numerous objects and advantages will become apparent to those skilled in the art by reference to the accompanying drawings in which:

FIG. 1 is a perspective view of a first embodiment of a tab locked reflector assembly system showing a first variation of the reflector and a first variation of the top plate;

FIG. 2 is an enlarged bottom view of the reflector of FIG. 1;

FIG. 3 is an enlarged perspective view of the reflector of FIG. 1;

FIG. 4 is an enlarged cross-section view of the reflector of FIG. 1;

FIG. 5 is an enlarged perspective view of the top plate of FIG. 1;

FIG. 6 is a top view of the top plate of FIG. 5;

FIG. 7 is an enlarged perspective view of a second variation of the top plate;

FIG. 8 is a top view of the top plate of FIG. 7;

FIG. 9 is an enlarged perspective view of a third variation of the top plate;

FIG. 10 is a top view of the top plate of FIG. 9;

FIG. 11 is an exploded perspective view of a second embodiment of a tab locked reflector assembly system showing a second variation of the reflector and a fourth variation of the top plate;

FIG. 12 is a perspective view of the reflector of FIG. 11;

FIG. 13 is an enlarged top view of the top plate of FIG. 11;

FIG. 14 is a front view of the reflector of FIG. 11;

FIG. 15 is a cross-section view of the reflector of FIG. 11;

FIG. 16 is a perspective view of a third variation of the reflector;

FIG. 17 is a perspective view of a fourth variation of the reflector;

FIG. 18 is an enlarged side view of the spring clip upper segment of FIG. 11; and

FIG. 19 is an enlarged side view of the spring clip lower segment of FIG. 11.

### DETAILED DESCRIPTION

With reference to the drawings wherein like numerals represent like parts throughout the several figures, a tab locked reflector assembly system in accordance with the present disclosure is generally designated by the numeral 10, 10′.

Light emitting diode (LED) modules suitable for use in recessed light fixtures are produced in a variety of sizes, having different diameter bases that must extend through an opening in the upper end of the downlight fixture reflector to connect with an electrical socket. Accordingly, a variety of downlight fixture reflectors must be produced to accommodate the range of LED module bases. In addition, the light emitted by different LED modules require that the downlight fixture reflector lower sections have different internal contours to properly direct the light. Producing downlight fixture reflectors using conventional methods substantially requires that each combination of upper end opening/lower section contour be assembled with tooling and fixtures that are specific to that combination. Each downlight fixture reflector 12, 12′ manufactured using the tab locked reflector assembly system 10, 10′ may be assembled using a single tooling/fixture.

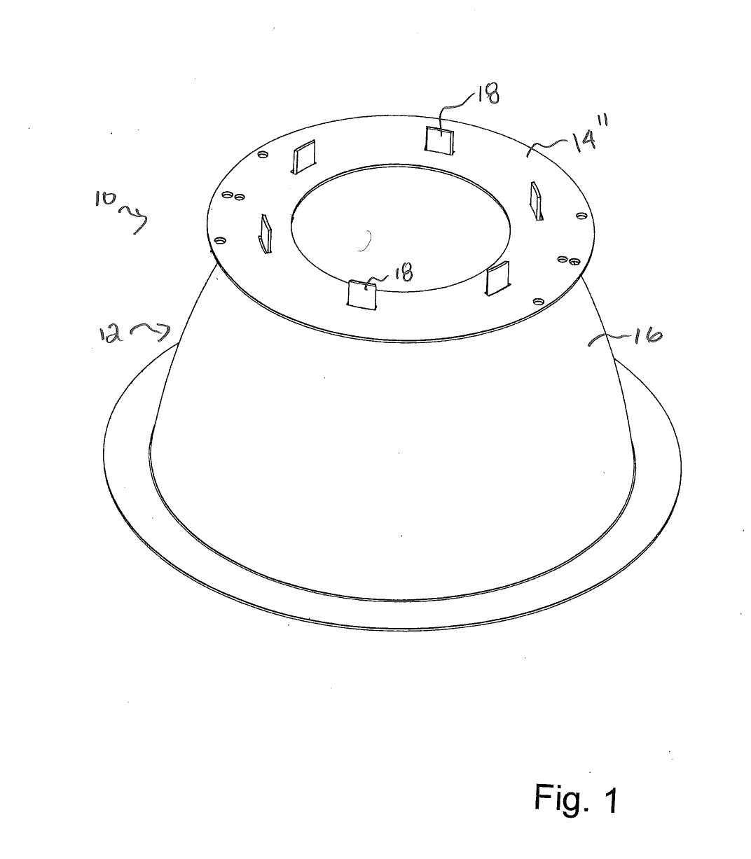

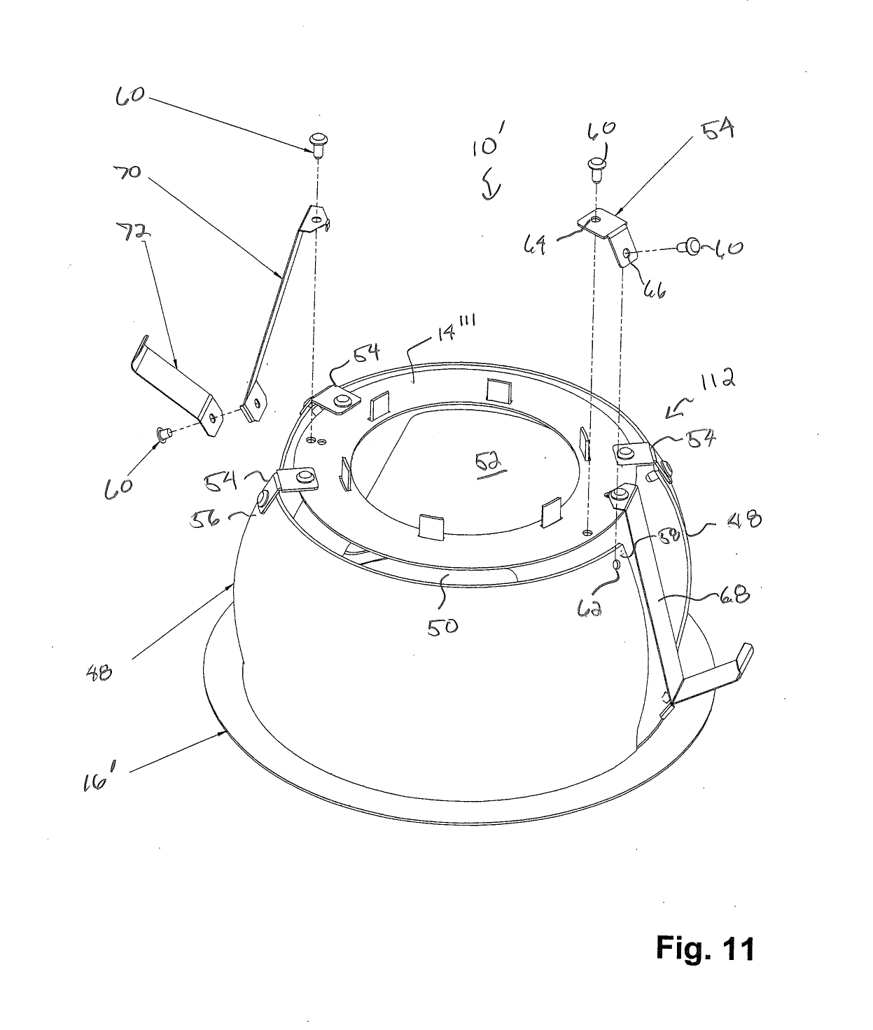

With reference to FIGS. 1 and 11, the tab locked reflector assembly system 10, 10′ includes multiple varieties of top plates 14, 14′, 14″, 14′″ and multiple varieties of reflector members 16, 16′, 16″, 16′″. Each of the reflector members 16, 16′, 16″, 16′″ includes multiple tabs 18 that extend upwardly from an upper edge 20 of the reflector member 16, 16′, 16″, 16′″. Each of the top plates 14, 14′, 14″, 14′″ includes a corresponding number of slots 24, 24′, 24″ to receive the reflector member tabs 18. As explained in greater detail below, the downlight fixture reflector 12, 12′ is assembled by inserting the tabs 18 of a selected reflector member 16, 16′, 16″, 16′″ through the slots 24, 24′, 24″ of a selected top plate 14, 14′, 14″, 14′″ and bending the tabs 18 radially outward to mount the top plate 14, 14′, 14″, 14′″ to the reflector member 16, 16′, 16″, 16′″.

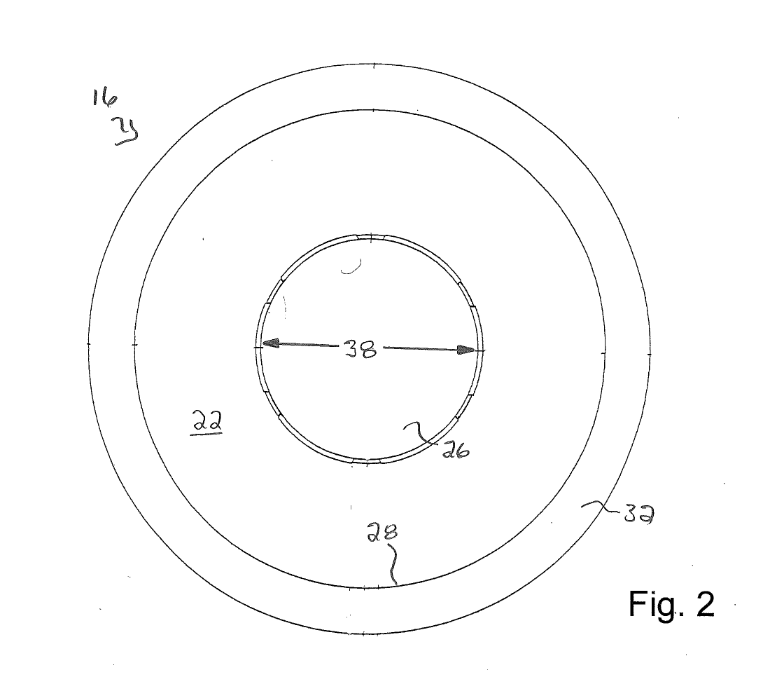

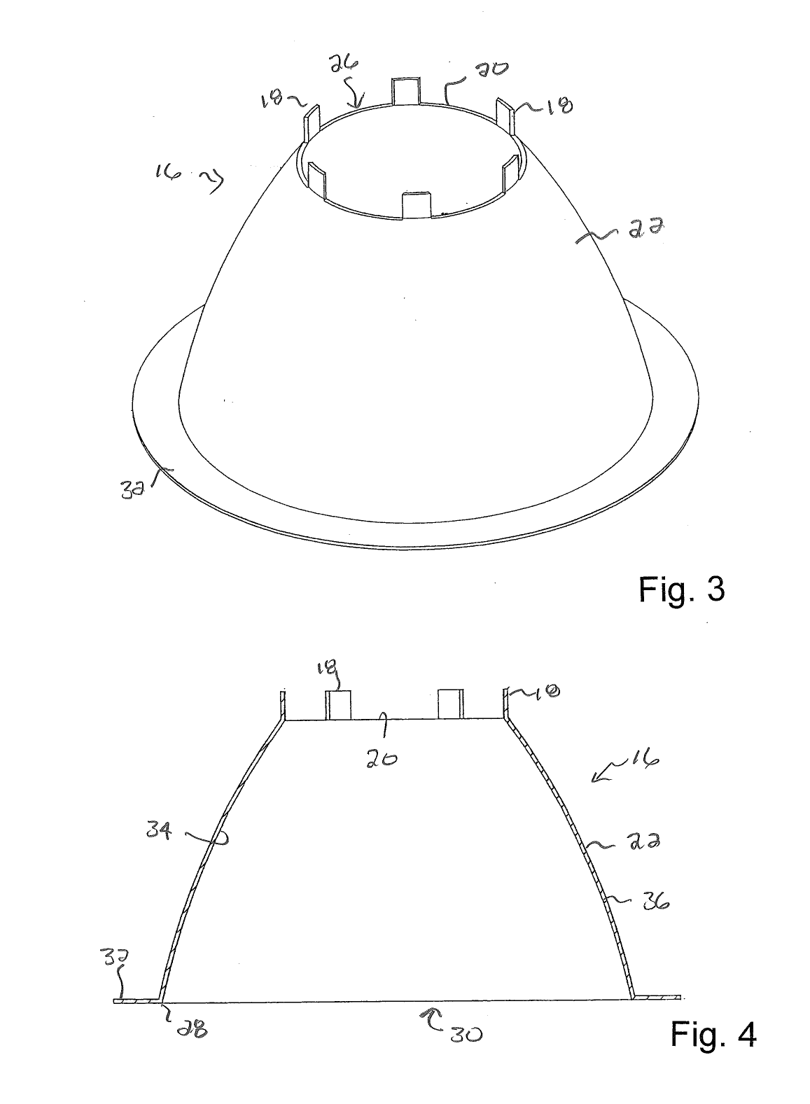

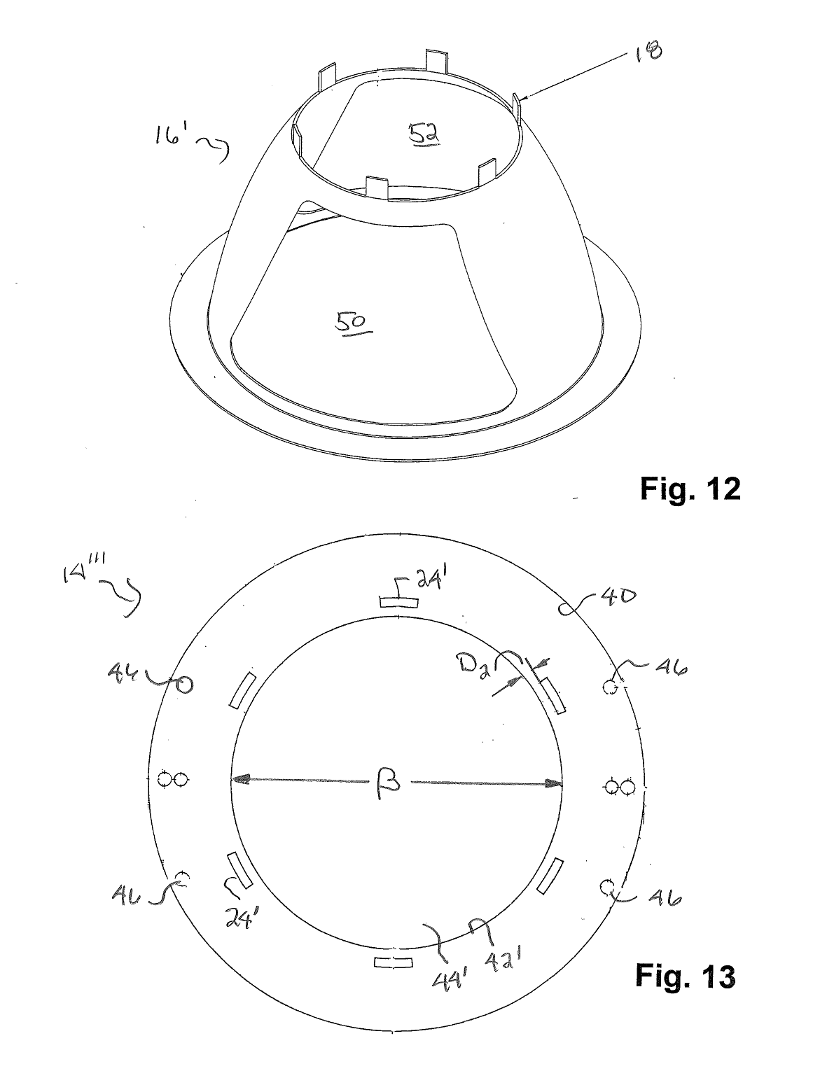

With reference to FIGS. 2-4, 11, 12, 16 and 17, the reflector members 16, 16′, 16″, 16′″ include varieties designed to house conventional LED modules. Each reflector member 16, 16′, 16″, 16′″ has a generally conically shaped body section 22, 22′, 22″ in which the LED module is housed when installed. Multiple tabs 18 extend upwardly from the upper edge 20 of the reflector member 16, 16′, 16″, 16′″. The upper edge 20 also defines an opening 26 through which an electrical receptacle may be inserted when the downlight fixture reflector 12, 12′ is installed. Alternatively, the base of the LED module may be inserted through the opening 26 into an electrical receptacle disposed above the installed downlight fixture reflector 12, 12′.

The lower edge 28 of the reflector member 16, 16′, 16″, 16′″ defines a round light exit aperture 30. A trim ring 32, 32′ extends radially outward from the reflector member lower edge 28 (FIGS. 1-4, 11, 12, 16, 17) or has a first section that extends radially outward and a second section that extends upward and radially outward (FIG. 17). As seen in FIG. 4, the inner surface 34 of the body section sidewall 36 may have a curvilinear shape to facilitate reflecting light emitted by the LED module out of the exit aperture 30. The height of the body section 22, 22′, 22″, the curvature of the inner surface 34 and the diameter of the light exit aperture 30 of a variety of reflector member 16, 16′, 16″, 16′″ are predetermined on the basis of the physical dimensions and light emitting characteristics of range LED modules that will be installed in the downlight fixture reflector 12, 12′. It should be appreciated that other varieties of reflector members 16, 16′, 16″, 16′″ may be manufactured having different body section heights and/or inner surface curvatures and/or light exit aperture diameters for use with LED modules that have physical dimensions and/or light emitting characteristics that fall outside of the original selected range of LED modules. The diameter of opening 26 is predetermined on the basis of the LED module, in the range LED modules that will be installed in the downlight fixture reflector 12, 12′, having the widest diameter base dimension.

With reference to FIGS. 5-10 and 13, the top plates 14, 14′, 14″, 14′″ are substantially planar circular discs having a circumferential outer edge 40 and an inner edge 42, 42′, 42″ defining an inner opening 44, 44′, 44″. Multiple slots 24, 24′, 24″ for receiving the reflector member tabs 18 extend laterally through the disc. The inner opening 44, 44′, 44″ of each of the varieties of top plate 14, 14′, 14″, 14′″ has a diameter α, β, γ, where α is greater than β and β is greater than γ.

As explained above, the downlight fixture reflector 12, 12′ is intended for use for a range of LED modules that have different characteristics and the diameter of the reflector opening 26 is selected on the basis of the LED module having the widest diameter base dimension. The use of different varieties of top plates 14, 14′, 14″, 14′″ allows the downlight fixture reflector 12, 12′ to be customized to interface with specific LED modules within the selected range.

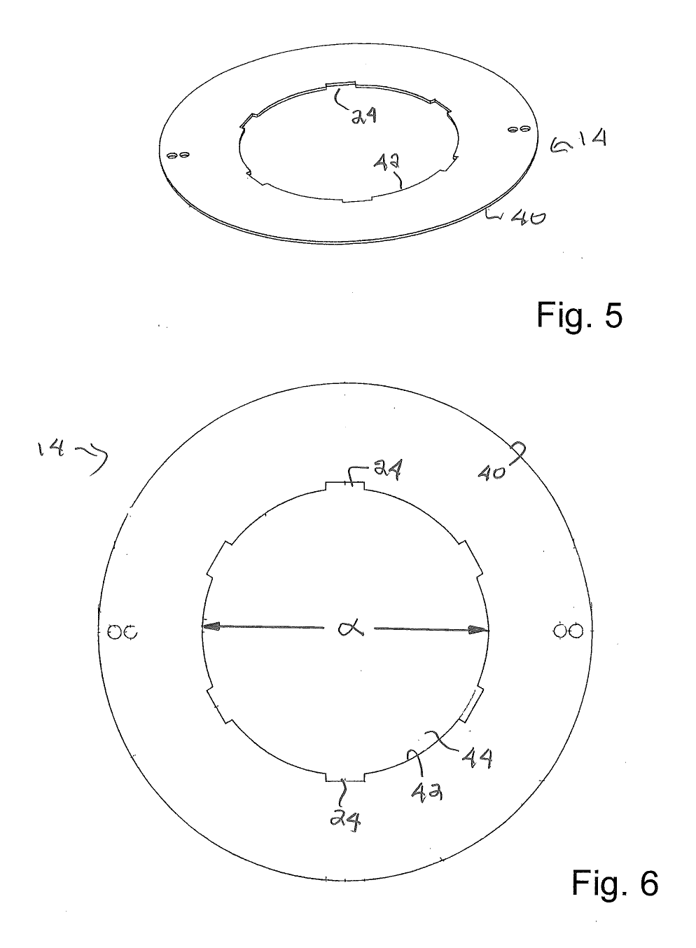

With additional reference to FIGS. 5 and 6, the first variety of top plate 14 is intended for use with the LED module, in the range LED modules that will be installed in the downlight fixture reflector 12, having the widest diameter base dimension. More specifically, the diameter α of inner opening 44 is substantially equal to the diameter of opening 26. The slots 24 extend radially outward from the inner edge 42.

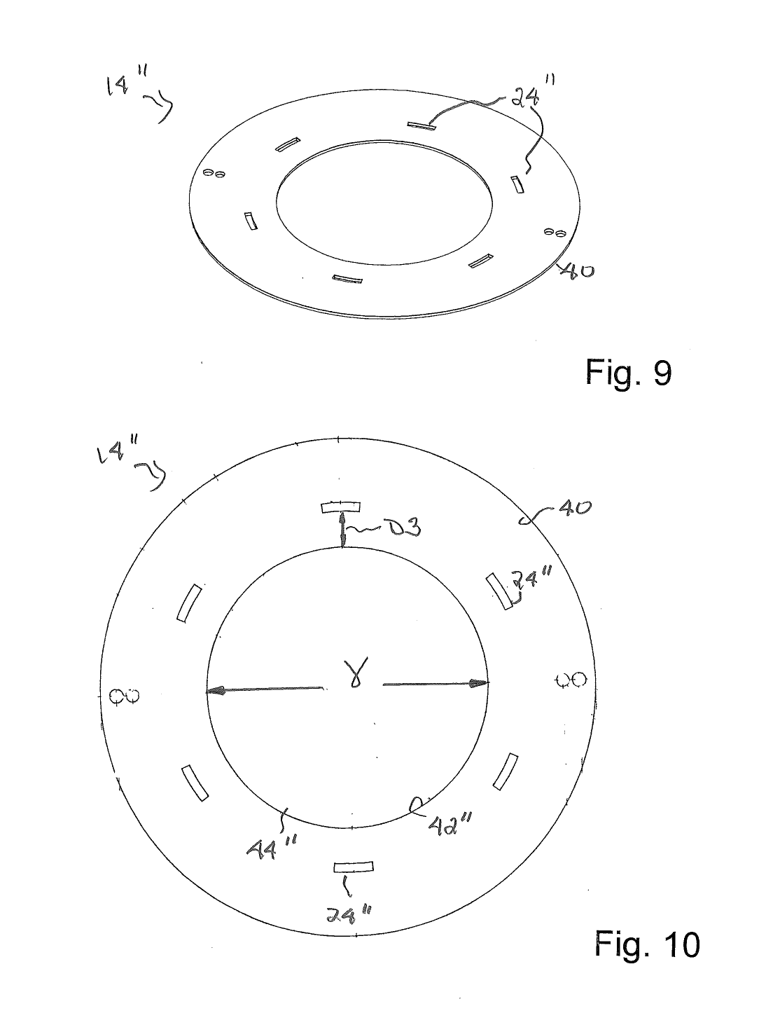

With additional reference to FIGS. 9 and 10, the third variety of top plate 14″ is intended for use with the LED module, in the range LED modules that will be installed in the downlight fixture reflector 12, having the smallest diameter base dimension. Accordingly the diameter γ of inner opening 44″ is smaller than the diameter α of inner opening 44 and the slots 24″ are positioned at a distance D3 radially outward from the inner edge 42″.

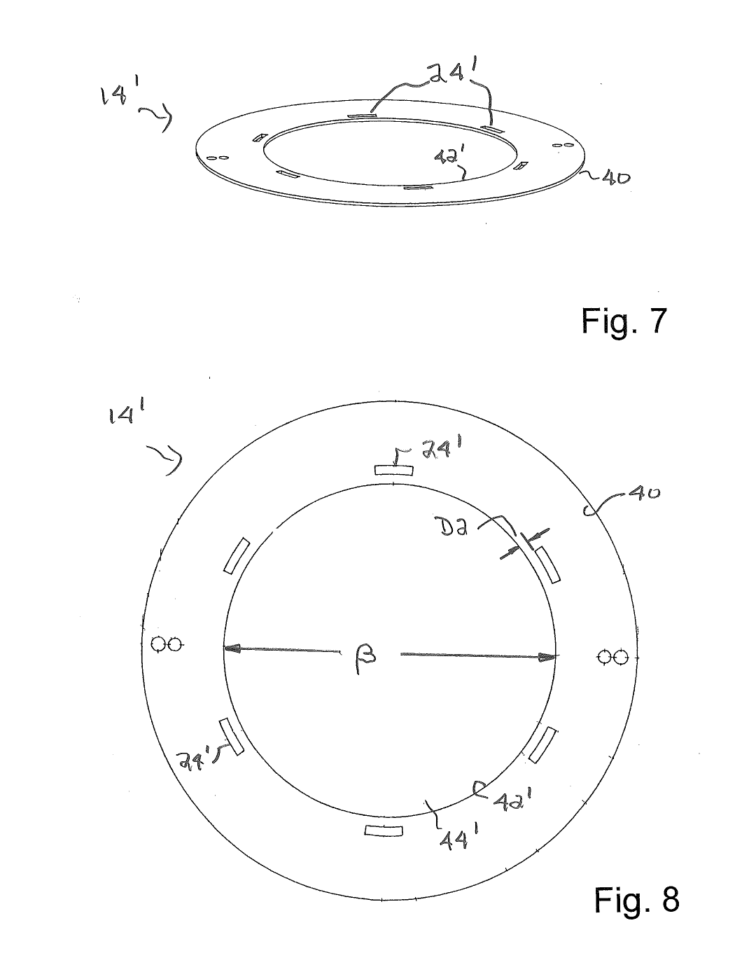

With additional reference to FIGS. 7, 8 and 13, the second and fourth varieties of top plate 14′, 14′″ are intended for use with a LED module, in the range LED modules that will be installed in the downlight fixture reflector 12, 12′, having an intermediate diameter base dimension. Accordingly the diameter β of inner opening 44′ is smaller than the diameter α of inner opening 44 and larger than the diameter γ of inner opening 44″. The slots 24′ are positioned at a distance D2 radially outward from the inner edge 42′, where D3 is greater than D2. The fourth variety of top plate 14′″ is a variation of the second variety of top plate 14′, having openings 46 for mounting the kicker plate 48 of the reflector system second embodiment 10′.

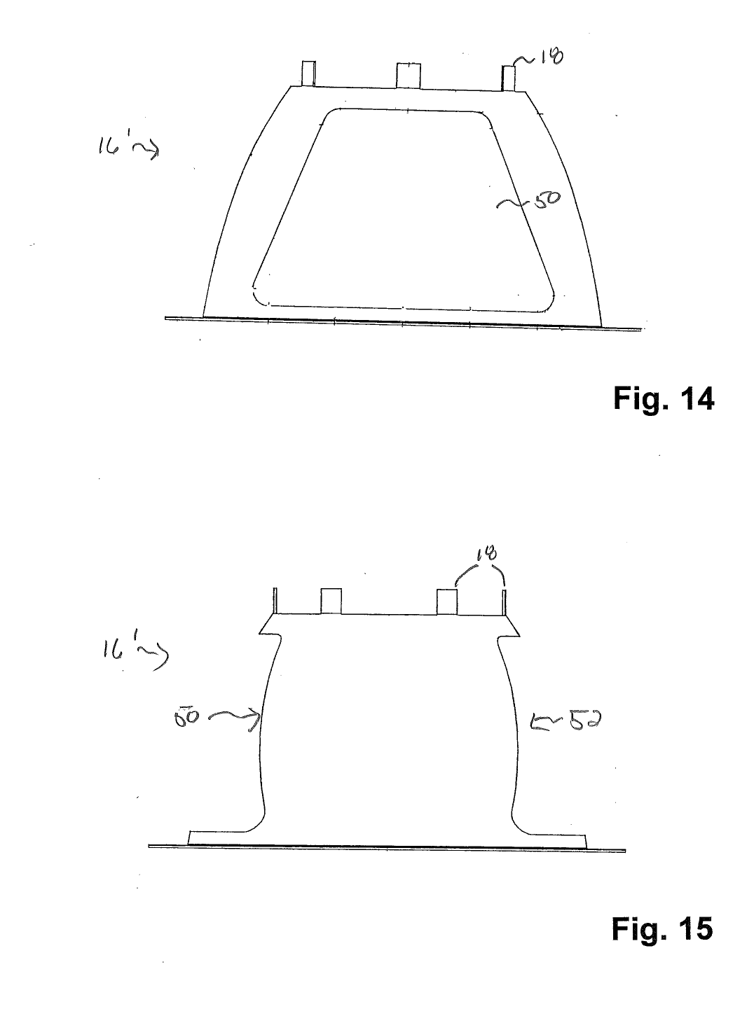

With reference to FIGS. 11-15, the reflector system second embodiment 10′ is a double wall wash reflector 12′. The reflector member 16′ of the double wall wash reflector 12′ has a pair of oppositely disposed openings 50, 52 in the body section 22′. The openings 50, 52 may have a trapezoidal-shape, as shown in FIG. 14. Light emitted transversely outward through the two openings 50, 52 is reflected substantially downward by two kicker plates 48 such that the light “washes” walls adjacent to the reflector 12′. The kicker plates 48 are permanently connected to the top plate 14′″ by brackets 54 mounted to the upper corners 56, 58 of the kicker plates 48 and the top plate 14′″ by fasteners 60, such as rivets, openings 62, 46, 64, 66 being provided in the kicker plates 48, top plate 14′″ and fasteners 60 for receiving the fasteners 60.

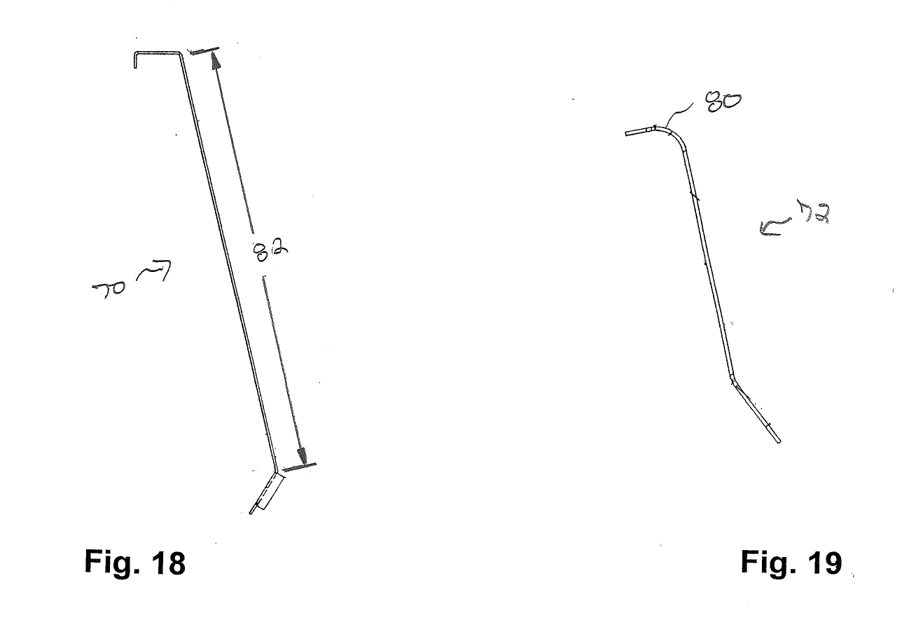

With additional reference to FIGS. 18 and 19, a pair of spring clips 68 are also mounted to the top plate 14′″ by fasteners 60. Each of the spring clips 68 includes upper and lower segments 70, 72. The spring clips 68 facilitate positioning and mounting the reflector 12, 12′ within the lighting fixture (not shown). Retainer clips used to mount conventional reflectors generally apply excessive spring force against the outer surface of the reflector resulting in gouging of the reflector surface. In addition, the force required to insert the reflector within the lighting fixture can result in vertical displacement of the lighting fixture. Flexure of the spring clip upper and lower segments provides a predetermined amount of spring force that is sufficient to ensure retention of the reflector assembly system 10, 10′ within the lighting fixture while eliminating gouging of any surfaces. The two-piece construction of the spring clips 68 facilitates use of the spring clips 68 with reflector members 16 having different heights. The length 82 of the upper segment 70 may be lengthened for use with higher reflector members or shortened for use with shorter reflector members.

The curved outer end 80 of the lower segment also provides a self-indexing feature for locating the reflector assembly system 10, 10′ within the lighting fixture. This is particularly significant for positioning single and double wall wash reflectors. With conventional retainer clips, elements of the lighting fixture frame can interfere with the retainer clip. This requires the frame to be oriented during installation such that the retainer clip will properly engage the frame when the reflector is positioned to wash the target wall/corner. The lighting fixture frame cannot interfere with the spring clips 68 allowing the frame to be installed without regard to orientation.

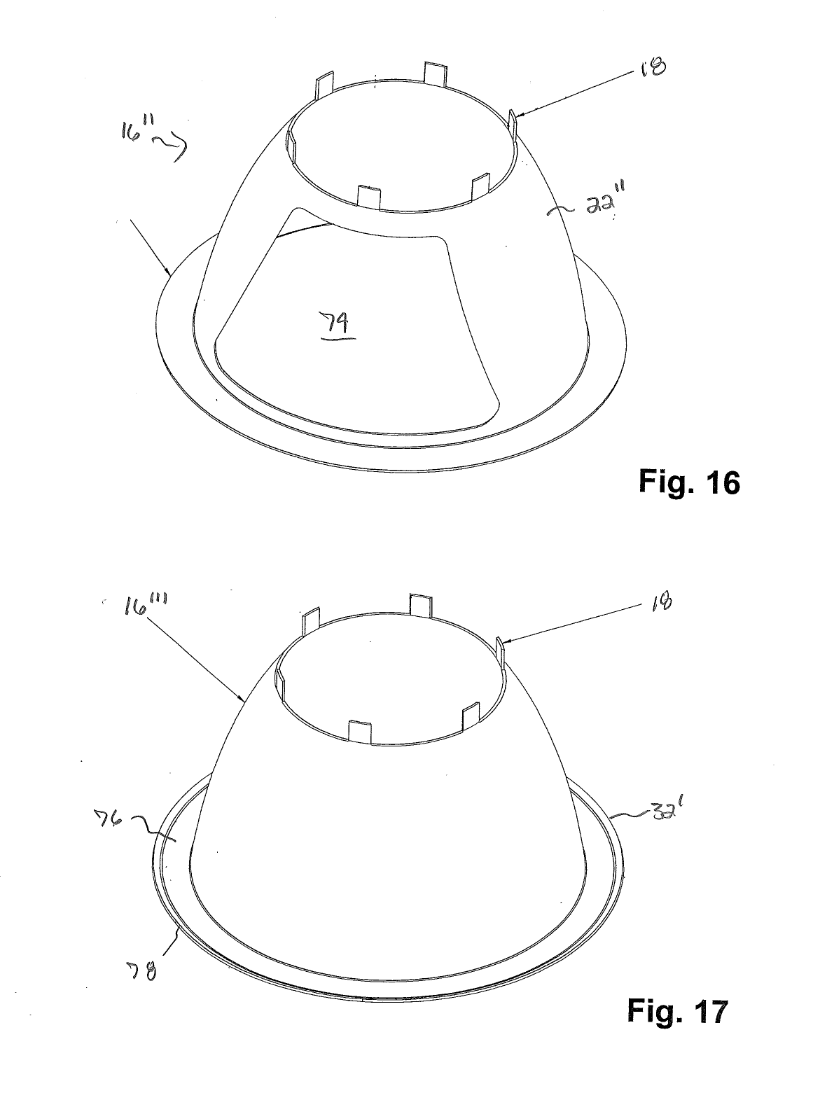

The reflector member 16″ shown in FIG. 16 is for a single wall was reflector (not shown) and is substantially identical to the reflector member 16′ for the double wall wash reflector 12′ except that it has only a single opening 74 in the body section 22″. The reflector member 16″ shown in FIG. 17 has a trim ring 32′ that has a first section 76 that extends radially outward and a second section 78 that extends upward and radially outward.

It should be appreciated that use of the slots 24, 24′, 24″ and tabs 18 mechanically locks the top plate 14, 14′, 14″, 14′″ in position relative to the reflector member 16, 16′, 16″, 16′″ before the tabs 18 are bent, thereby preventing the relative rotation problem prevalent in manufacturing conventional downlight fixture reflectors. Accordingly, each variety of the top plates 14, 14′, 14″, 14′″ may be mounted to the reflector members 16, 16′, 16″, 16′″ using a single tooling/fixture.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A tab locked reflector assembly system comprises:
a reflector member having a body section and a plurality of tabs extending upwardly from an upper edge of the body section; and
a top plate defining a plurality of slots, each tab of the reflector being receivable within a corresponding slot of the top plate;
wherein the reflector member is mounted to the top plate by inserting the tabs through the corresponding slots and bending the tabs orthogonally to the reflector member body section.

2. The reflector assembly system of claim 1 wherein the reflector member body section upper edge defines an opening having a diameter.

3. The reflector assembly system of claim 2 wherein the opening is adapted to receive an electrical receptacle or the base of an LED module.

4. The reflector assembly system of claim 2 wherein the reflector member body section also includes a sidewall extending from the upper edge to a lower edge, the lower edge defining a light exit aperture having a diameter.

5. The reflector assembly system of claim 4 wherein the reflector member body section also includes a trim ring extending radially outward from the lower edge.

6. The reflector assembly system of claim 4 wherein the reflector member body section also includes a trim ring having a first section extending radially outward from the lower edge and a second section extending upward and radially outward from the first section.

7. The reflector assembly system of claim 4 wherein the reflector member body section sidewall has a height and an inner surface having a curvilinear shape, the height of the body section, the curvature of the inner surface, the diameter of the opening and the diameter of the light exit aperture having predetermined values.

8. The reflector assembly system of claim 4 wherein the top plate is a substantially planar circular disc having a circumferential outer edge and an inner edge defining an inner opening.

9. The reflector assembly system of claim 8 wherein the top plate inner opening has a diameter adapted interface with specific LED modules.

10. The reflector assembly system of claim 9 wherein the diameter of the top plate inner opening is substantially equal to the diameter of the body section opening and the slots extend radially outward from the top plate inner edge.

11. The reflector assembly system of claim 9 wherein the diameter of the top plate inner opening is smaller than the diameter of the body section opening and the slots are positioned at a distance radially outward from the inner edge.

12. The reflector assembly system of claim 9 further comprising at least one kicker plate, the reflector member body section sidewall defining at least one opening, the kicker plate being disposed adjacent the sidewall opening whereby light emitted transversely outward through the sidewall opening is reflected substantially downward by the kicker plate.

13. The reflector assembly system of claim 12 wherein reflector assembly system comprises two kicker plates and the reflector member body section sidewall defines a pair of oppositely disposed openings, a one of the kicker plates being disposed adjacent each of the sidewall openings.

14. The reflector assembly system of claim 12 further comprising brackets mounting the at least one kicker plate to the top plate.

15. The reflector assembly system of claim 4 further comprising a plurality of spring clips, each of the spring clips including an upper segment and a lower segment, the upper segment having an upper end and a lower end, the upper segment upper end being mounted to the top plate, the lower segment extending radially outward from the upper segment lower end, the lower segment having a distal end segment adapted to engage a lighting fixture.

16. The reflector assembly system of claim 15 wherein the spring clip lower segment has a proximal end segment mounted to the spring clip upper segment lower end.

17. A lighting reflector assembly system comprises:
a plurality of varieties of reflector members, each reflector member including an upper edge, a lower edge and a sidewall extending from the upper edge to the lower edge, the upper edge defining an opening having a diameter, the lower edge defining a light exit aperture having a diameter, the sidewall having a height and an inner surface having a curvilinear shape, the sidewall height, the curvature of the sidewall inner surface, the diameter of the opening and the diameter of the light exit aperture of each variety of the reflector members defining a combination of characteristics of the variety of the reflector members, wherein the combination of characteristics of each variety of the reflector members is different from the combination of characteristics of each other variety of the reflector members;
a plurality of varieties of top plates, each top plate being a substantially planar circular disc having a circumferential outer edge defining a diameter and an inner edge defining an inner opening defining a diameter, the diameter of the inner edge and the diameter of the outer edge of each variety of the top plates defining a combination of characteristics of the variety of the top plates, wherein the combination of characteristics of each variety of the top plates is different from the combination of characteristics of each other variety of the top plates;
said reflector members and said top plates being structured so each variety of the reflector members is mountable to each variety of the top plates.

18. The reflector assembly of claim 17 wherein each reflector member also includes a plurality of tabs extending upwardly from the upper edge and each top plate also defines a plurality of radially spaced slots, each tab of the reflector being received in a corresponding slot of the top plate, the reflector member being mounted to the top plate by bending the tabs orthogonally to the reflector member sidewall.

19. The reflector assembly system of claim 18 wherein the reflector member also includes a trim ring extending radially outward from the lower edge.

20. The reflector assembly system of claim 18 wherein the reflector member also includes a trim ring having a first section extending radially outward from the lower edge and a second section extending upward and radially outward from the first section.

21. The reflector assembly system of claim 18 wherein the reflector member opening is adapted to receive an electrical receptacle or the base of an LED module.

22. The reflector assembly system of claim 21 wherein the top plate inner opening has a diameter adapted interface with specific LED modules.

23. The reflector assembly system of claim 18 wherein the slots of a first variety of top plates extend radially outward from the inner edge.

24. The reflector assembly system of claim 18 wherein the slots of a second variety of top plates are positioned at a distance radially outward from the inner edge.

25. The reflector assembly system of claim 18 further comprising at least one kicker plate, the reflector member sidewall defining at least one opening, the kicker plate being disposed adjacent the sidewall opening whereby light emitted transversely outward through the sidewall opening is reflected substantially downward by the kicker plate.

26. The reflector assembly system of claim 25 wherein reflector assembly system comprises two kicker plates and the reflector member sidewall defines a pair of oppositely disposed openings, a one of the kicker plates being disposed adjacent each of the sidewall openings.

27. The reflector assembly system of claim 25 further comprising brackets mounting the at least one kicker plate to the top plate.

28. The reflector assembly system of claim 18 further comprising a plurality of spring clips, each of the spring clips including an upper segment and a lower segment, the upper segment having an upper end and a lower end, the upper segment upper end being mounted to the top plate, the lower segment extending radially outward from the upper segment lower end, the lower segment having a proximal end segment mounted to the spring clip upper segment lower end and a distal end segment adapted to engage a lighting fixture.
